(19) United States
(12) Patent Application Publication
(10) Pub. No.: US 2015/0308852 A1
(43) Pub. Date: Oct. 29, 2015

(54) NAME BASED GPS NAVIGATION SYSTEM

(71) Applicant: Ari Kahtan, Tel Aviv (IL)

(72) Inventor: Ari Kahtan, Tel Aviv (IL)

(21) Appl. No.: 13/988,924

(22) PCT Filed: Nov. 21, 2011
(86) PCT No.: PCT/IL2011/000895

§ 371 Date: Jan. 10, 2014

(30) Foreign Application Priority Data
Nov. 22, 2010 (IL) 209501

(51) Int. Cl. G01C 21/36; G06Q 50/00

(52) U.S. Cl. CPC G01C 21/3679; G06Q 50/01

(57) ABSTRACT

A system for providing navigation service based on information distributed online to users listed to the navigation service. The system comprises (a) a satellite navigation device operable to receive satellite navigation signals, determine the navigation device current geographic location, and direct the user of the navigation device to a desired geographic location; (b) a wireless Ethernet transceiver embedded in the navigation device, operable to communicate with a remote server over the Internet; and (c) a remote server operable to receive data from the Ethernet transceiver through a Website, store the data, and distribute derivatives of the data to listed users which query the data, which is represented by short strings of characters which are utilized by the users when querying the data.

### FIELD OF THE INVENTION

The present invention relates to distributing positioning information of a positioning system. More particularly, the invention relates to utilizing a data network to distribute satellite positioning system information to roving said positioning system receivers.

### BACKGROUND OF THE INVENTION

Global Positioning System (GPS) is a space-based global navigation satellite system that provides reliable location information at all times and anywhere when and where there is an unobstructed line of sight to four or more GPS satellites. The location information is received by a GPS device which uses for providing the user its location and for directing him to a desired place.

Traditional navigation applications installed in users GPS devices allow navigation based on a database stored in the device, namely, addresses and Points Of Interest (POI) (e.g., banks, cinemas, hospitals etc.). Typically, when the user queries a destination, he is requires to provide the full address of the desired destination or the name of its POI. However, GPS devices fail to direct users when the address or the POI provided is not stored in their memory. Furthermore, typing the full address into the GPS device is sometime tedious and time consuming. In order to provide a full address, namely, state, city, street and number, the user is required to type an average of 13 characters.

Traditional navigation applications suffer from a limited database. The list of addresses and POI is limited to the software updates released to the public. Typically, the database released with the navigation software is enormous. This database contains all the major addresses and POI updated by the software owner. However, often a user needs to navigate to a private point of interest, which is not included in the global database of his device, namely, a certain location familiar to him or to his social circle. For example, a small private office belongs to a friend or a new restaurant opened in the neighborhood which is not updated in the software database yet. The private POI also include places without an address, such as, for example, isolated ranches, rest areas on highways, parks etc. Utilizing traditional navigation applications does not support navigating users to their private POI. Even in devices in which the user can update his private POI, those points are visible only in his device. Therefore it is impossible to share this data with his social circle in order for hem to navigate to his private POI.

Today, some systems offer real-time interactive distributed navigation through the use of a wireless module embedded into the user's GPS device. The wireless module communicates over a wireless carrier to a remote server that performs various navigation related functions and returns navigation information to the wireless module for review by an operator. However, distributed navigation systems have a somewhat limited feature set and offer limited functions. Conventional distributed navigation systems have a user interface that is awkward and less than user friendly. Also, the amount of navigation information related to a particular operation often may be quite large. As the amount of navigation information increases, it exceeds the storage capacity of the wireless module and introduces an additional delay during operation while large amounts of navigation information are being conveyed to the wireless GPS device.

US 2010/0094536 discloses an off-board navigation application that comprises a menu hierarchy associated with points of interest (POIs). The menu is adapted to present address information related to a selected point of interest (POI). The menu includes a function option that directs the portable device to transmit wirelessly a navigation information request to a remote server. The menu is adapted to present navigation information that is received wirelessly by the portable device from the remote server in response to the navigation information request. Optionally, the application may further presents a list of POI names, wherein address information is presented in response to the selected POI. The portable device is adapted to transmit a navigation information request to the remote server. The navigation information request instructs the remote server to perform a route calculation from a present location of the portable device to the selected POI. US 2010/0094536 presents address information in response to a selected POI. However Those POIs are associated with addresses and are not adapted to direct users to address-less locations by being updating coordinates in real-time and distributing them to other users.

None of the currently available techniques provide a satisfying solution for a distributed navigation system which can be updated with location information relevant to the user in real-time. Therefore, there is a need for a system that allows users to update online personal information and to distribute said information with their social circle. The system should provide a user friendly interface which supports fast and easy insertion of navigation information and queries.

It is therefore an object of the present invention to provide a system for inserting and updating personal and location information online.

Another object of the present invention is to provide a social network which allows users to select listed members and establish a social circle.

Yet another object of the present invention is to provide a system for real-time distribution of personal and navigation information between friends.

Still an object of the present invention is to provide a method of navigating to a personal destination or to a destination without an address utilizing a fast and short query.

Other objects and advantages of the invention will become apparent as the description proceeds.

### SUMMARY OF THE INVENTION

The present invention is directed to a system for providing navigation service based on information distributed online to users listed to the navigation service, that comprises:
(a) a satellite navigation device operable to receive satellite navigation signals, determine the navigation device current geographic location, and direct the user of the navigation device to a desired geographic location;
(b) a wireless Ethernet transceiver embedded in the navigation device, operable to communicate with a remote server over the Internet; and
(c) a remote server operable to receive data from the Ethernet transceiver through a Website, store the data, and distribute derivatives of the data to listed users which query the data.
   wherein the data is represented by short strings of characters which are utilized by the users when querying the data.

The remote server may further serve a location-based social network, and distribute personal and location information between friends listed to the social network.

The Ethernet transceiver may be adapted to communicate location information taken from the group consisting of: geographical address, geographical coordinates, location name, phone number, and e-mail address.

The remote server may be adapted to provide the location information associated with a specific user as a result of querying the user name.

The Website may be provided by the navigation service provider and may allow users to open an account, provide a personal username, add and update locations, provide personal location names, and operate a social network account.

The remote server may store the personal and location information in tables in which each entry is associated with a specific user.

The satellite navigation device may comprise an SOS activator to sent alert to selected destinations when the activator is activated.

The satellite navigation device may be a hand-held GPS device.

The remote server may be further adapted to receive data from public places and offer their services to potential and relevant costumers.

### BRIEF DESCRIPTION OF THE DRAWINGS

The above and other characteristics and advantages of the invention will be better understood through the following illustrative and non-limitative detailed description of embodiments thereof, with reference to the appended drawings, wherein:

FIG. 1 illustrates a schematic representation of a GPS utilized with an embodiment of the present invention.

### DETAILED DESCRIPTION OF THE INVENTION

In the following description, for the purpose of illustration, numerous specific details are provided. As will be apparent to the skilled person, however, the invention is not limited to such specific details and the skilled person will be able to devise alternative arrangements.

The system according to the present invention provides a navigation service to positioning system users based on location information distributed online. Global Positioning System (GPS) is one kind of a satellite positioning and navigation system. A satellite positioning and navigation system is referred hereinafter as GPS. The system according to the present invention provides a location-based social network in which users can open an account and provide personal and location information. Each member in the location-based social network can add or update location information (e.g., work address, home address, coordinates of a meeting place etc), and share it with his friends. As in typical social networks, the user and his friends form a “social circle”.

All the members which belong to the same “social circle” are virtually connected through the social network. Each user can watch the personal information added by his friends and can navigate to the destinations provided by them. The invention allows navigation according to users' personal information (e.g., name, address, phone number, e-mail address etc). In an embodiment of the present application, the personal information is represented by short strings of characters which are utilized by the users when querying friends and location data.

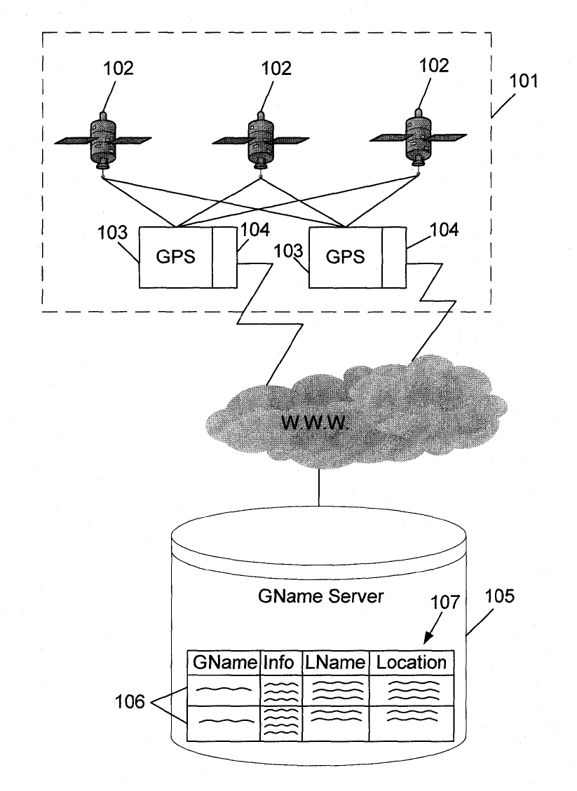

FIG. 1 represents a distributed navigation network 100 that includes a plurality of satellites 102, and GPS wireless user devices 103. Each GPS user devices 103, comprises a GPS receiver that scans radio frequencies for GPS signals from the satellites 102. Upon receiving radio signals from the GPS satellites 120, the GPS device 103 calculates its three-dimensional position. Each GPS devices 103 also includes a wireless Ethernet transceiver (transmitter and receiver) 104 that is configured to wirelessly communicate over bidirectional Internet links with a remote server 105. The wireless Internet connection can be provided utilizing cellular provider's antennas, wireless Internet carrier's gateways, or any other known method for delivering wireless Internet.

The system according to the present invention comprises a remote server 105 for managing the data communication between the users of the distributed navigation network and the service provider. Users which posses a GPS device 103 according to the system of the present invention can browse to a Website provided by the navigation service provider, open an account and provide a personal username. The personal user name is referred hereinafter as “GName”. Once the user is listed to the navigation service, he can start build his social circle, join new friends, and provide his private and location information. The user can provide to the system locations of places which he finds relevant for distributing with his friends, for example, the user's home, work etc. Users can provide the locations by address or by coordinates. When the user wishes to provide location of a place that has no address, he can provide the coordinates of the location.

The service provider's Website allows users to add and update locations and provide user-friendly names for them. A location name is referred hereinafter as “LName”. For example, a user named Michael Jordan joins the navigation system, provides a GName, “Michael 23”, provides his home LName and location, “My home; 676 North Michigan Avenue, Chicago, USA”, and provides his summer house LName and location, “Summer house; 37.016084-48.3783439”. Since Jordan's summer house is located in an open area without an address, Jordan provides the coordinates of the location. Using the coordinates provided Jordan's friends can navigate easily to his summer house. Utilizing GNames and LNames for the navigation saves time when operating the GPS device, thus reduces the probability for a car accident.

In one embodiment, the site provides a map and a GPS coordinates converter. If the user wishes to share the coordinate of his current location, he can export the coordinates from his GPS device to the Website. Alternatively, if the user wishes to share the coordinate of another location which he intends to visit in the future, he can use the GPS coordinates converter and point the location at a map provided. The coordinates converter then extracts the coordinates of the pointed location for the user to share with his friends. Each location can be updated with advanced characters and personal information. For example, home location can include the floor number, the apartment number, etc. Office location can include commercial logo, advertisement, working hours, etc. By accessing the user's information, the user's friends may see his current location even when the user did not update his current location.

Remote server 105 stores all the information related to the users listed to the navigation system. In one embodiment, the information is stored in tables. Each entry in the tables 106 is associated with a specific user by his GName. Each GName (e.g., “Michael 23”) is associated to the LNames (e.g., “Summer house”) and their actual locations (e.g., “630084-4833439”) as provided by the GName owner. The remote server holds the GNames of all the users listed to the navigation service. The user's GPS device of the present invention allows its users to search for other users according to their GName. A software module stored in the UPS device is adapted to query the remote server for the GName that requested by the user. Once the requested GName is located in the remote server, the information associated with it is retrieved to the user's GPS device and presented to him. The user's GPS device is adapted to direct the user to each location appear in the information retrieved.

The software module that runs on the user's GPS device provides a user friendly interface which supports fast and easy insertion of navigation information and queries. The user is not required to select the country, city, street etc for navigating to the required destination. Once the user queries a specific GName, all the information provided by the owner of this GName is presented to him. In an embodiment of the present invention, each LName (location name associated to the GName) that is provided to the user is presented as a link. By selecting the LName link, the invention extracts the actual location (e.g., address, coordinates etc) as appear in the table 107, and provide it to the navigation module in the GPS device. Once the navigation module receives the actual location is directs the user to this location.

Table 107 further comprises general information such as, for example, email addresses and phone numbers of the listed users. The invention is adapted to query users also by their email address or phone number. In an embodiment of the present invention, the GPS device comprises an SOS activator. The user can update destinations to alert when the SOS activator is activated (e.g., police, family member, hospital etc).

In one embodiment the location-based social network which connects the listed members is provided by the navigation service provider, in another embodiment, the service provider utilizes exist social network. The social network utilized by the present invention allows its users to add to their social circle not only friends, but also public places (for example, restaurants, sport centers, museums etc). Each public place, commercial office and service provider can open an account in the Website of the navigation service provider and add information which they request to share with potential costumers.

By knowing the location of the users, the public place can publish location based information and advertisement to potential costumers. In an embodiment of the present invention, the public place is not required to have a GPS device, all the information and locations can be provided by the public place to the Website using a standard PC or other Internet access medium. Users can set their visibility permissions through the Website. For example, a new store that joins the service, can request to be seen by all the listed users. Each user can update in real-time his visibility permissions per each of his social circle members (e.g., sport store, friend etc). The visibility permissions allow users to control their information as published to other members.

In an embodiment of the system according to the present invention, the application executed by the navigation device supports SOS services. The application supports alerting each of the emergency authorities (e.g., police, fire service, emergency medical service etc) in the country. The application supports a very simple activation. In one embodiment, a user in an emergency situation clicks once to open a menu of emergency authorities and clicks one more time for sending an SOS signal to selected emergency authorities. The system is adapted to send the SOS signal along with the user current position, therefore, saves the need to guide the SOS team to the user's location.

The present invention further supports sending the SOS signal to predefined contact list (e.g., the user's friends in the social network utilized by the present invention). The alert can be delivered by any known method (e.g., SMS, MMS, E-mail etc). For example, a pregnant woman on her way to hospital to deliver starts delivering in her vehicle, the present application allows her to call an ambulance and provide her exact location by simply clicking her device twice.

Another service supported by the system according to the present invention is graves locating. As mentioned hereinabove, places without normal addresses can be added to the system database and recognize by a simple name and coordinates. Locating a specific grave in a graveyard is sometimes a problem since the graves have no address. The present invention allows each user to update his device with coordinates of his beloved ones graves. Each grave that is inserted to the system is associated with a specific name and coordinates for easy locating by its visitors. The Website provided by the present invention allows forming a virtual memorial site associated to the people which their graves were inserted to the system. Visitors which enter the Website can retrieve the location of their friend's graves. The destination name as provided to the system prior to navigating can be provided vocally. The present invention is adapted to receive the translated text and direct the user to the desired location.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A system for providing navigation service based on information distributed online to users listed to said navigation service, comprising:
(a) a satellite navigation device operable to receive satellite navigation signals, determine said navigation device current geographic location, and direct the user of said navigation device to a desired geographic location;
(b) a wireless Ethernet transceiver embedded in said navigation device, operable to communicate with a remote server over the Internet; and
(c) a remote server operable to receive data from said Ethernet transceiver through a Website, store said data, and distribute derivatives of said data to listed users which query said data;
wherein said data is represented by short strings of characters which are utilized by said users when querying said data.

2. The system according to claim 1, wherein the remote server further serves a location-based social network, and distribute personal and location information between friends listed to said social network.

3. The system according to claim 1, wherein the Ethernet transceiver is adapted to communicate location information taken from the group consisting of: geographical address, geographical coordinates, location name, phone number, and e-mail address.

4. The system according to claim 1, wherein the remote server is adapted to provide the location information associated with a specific user as a result of querying said user name.

5. The system according to claim 1, wherein the Website is provided by the navigation service provider and allows users to open an account, provide a personal username, add and update locations, provide personal location names, and operate a social network account.

6. The system according to claim 1, wherein the remote server stores the personal and location information in tables in which each entry is associated with a specific user.

7. The system according to claim 1, wherein the satellite navigation device comprises an SOS activator to sent alert to selected destinations when said activator is activated.

8. The system according to claim 1, wherein the satellite navigation device is a handheld GPS device.

9. The system according to claim 1, wherein the remote server is further adapted to receive data from public places and offer their services to potential and relevant costumers.
